(19) United States
(12) Patent Application Publication
(10) Pub. No.: US 2005/0057069 A1
(43) Pub. Date: Mar. 17, 2005

(54) Cover for sanders and pick-up beds

(76) Inventor: Janice McNamara, Danbury, CT (US)

Correspondence Address: IRVING M. WEINER;WEINER & BURT, P.C., 635 N. US-23, P.O. BOX 186, HARRISVILLE, MI, 48740, US

(21) Appl. No.: 10/939,110

(22) Filed: Sep. 10, 2004

Related U.S. Application Data
(60) Provisional application No. 60/502,078, filed on Sep. 11, 2003.

(51) Int. Cl. B60P 7/04

(52) U.S. Cl. 296/100.16

(57) ABSTRACT

A cover for sanders and pick-up beds of all sizes and other equipment to keep rain, snow, etc. off the object to be covered. The cover is provided with a heavy duty elastic all around the outside of the cover. An optional feature is to provide the cover with magnets at the four corners thereof.

The present patent application claims priority from and is based on United States Provisional Patent Application Ser. No. 60/502,078 filed Sep. 11, 2003, the entire contents of which are incorporated herein by reference thereto.

The present invention relates generally to covers for sanders and pick-up beds.

More particularly, the present invention relates to covers for sanders and pick-up beds of all sizes wherein the cover has a heavy duty elastic band all around the outside of the cover.

### BACKGROUND OF THE INVENTION

There has been a need for a cover for sanders and pick-up beds wherein the user has easy access on and off to the equipment, without the necessity of tying or strapping a cover down.

The prior art is exemplified by: Scweickert U.S. Pat. No. 4,979,776 entitled “FABRIC COVER AND TIE DOWN SYSTEM FOR PICK-UP TRUCKS”; Hansen U.S. Pat. No. 5,050,924 entitled “EXPANDABILE TARPAULIN ASSEMBLY”; and Weyand U.S. Pat. No. 6,224,139 entitled “TARPAULIN COVER”.

It is a desiradatum of the present invention to avoid the animadversions of the conventional and prior art techniques and devices, and to provide a unique cover for sanders and pick-up beds of all sizes which eliminates the need for tying or strapping down the cover.

### SUMMARY OF THE INVENTION

The present invention provides a covering device for vehicles, equipment, and other external items, comprising: a main body portion fabricated from canvas material, polyplastic, nylon, or any other suitable material which is waterproof; and said main body portion is provided with a heavy duty elastic band disposed around an outer perimeter of said covering device to eliminate the need for tying or strapping down said covering device.

The present invention also provides a novel and unique cover for sanders and pick-up beds of all: sizes and other equipment which keeps rain, snow, dust, all types of precipitation, etc., off of the equipment in the pick-up bed.

It is an object of the present invention to provide a cover as described hereinabove wherein such cover is provided with a heavy duty elastic material all around the outside of the cover.

It is a further object of the present invention to provide a novel and unique cover as described hereinabove, wherein such cover permits easy access on and off to the equipment being covered.

Yet a further object of the present invention is to provide a cover as described hereinabove, wherein the need for tying or strapping down of the cover is no longer required.

Yet another object of the present invention is to provide a cover as described hereinabove, wherein the cover can be fabricated from canvas material, nylon, polyplastic, or any suitable material, as long as the material is waterproof to keep the contents dry.

The foregoing objects and further advantages of the present invention will become apparent to those skilled in this particular area of technology and to others after having read the following description in conjunction with the accompanying drawings.

### BRIEF DESCRIPTION OF THE DRAWINGS

FIG. 1 illustrates a partial perspective view of a pick-up truck having a cover in accordance with the present invention provided thereon.

FIG. 2 is an enlarged partial view showing the elastic band of the cover when it is stretched to be secured on the pick-up bed.

FIG. 3 is an enlarged perspective view of the section marked 3 in FIG. 1 showing the portion of the elastic band in its condition as remaining on the vehicle in FIG. 1.

FIG. 4 shows an optional feature of the invention involving a magnet placed at the corners of the inventive cover.

### DETAILED DESCRIPTION OF THE INVENTION

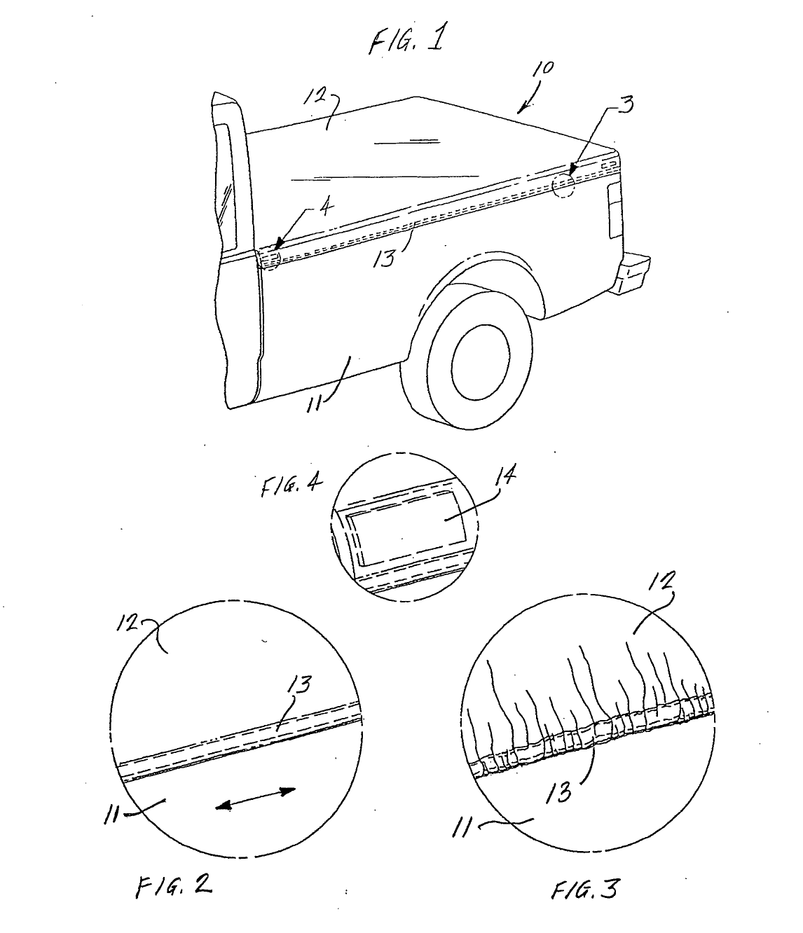

FIGS. 1-3 show the novel and unique cover 10 in accordance with the present invention which can be used for sanders and pick-up beds. The term sanders as used herein refers to trucks which spread sand on snow and ice with appropriate spreading equipment. The term pick-up beds as used herein refers to the beds of pick-up trucks 11.

Preferably, bat not necessarily, the cover 10 in accordance with the present invention would be approximately four feet by six feet, or four feet by eight feet, to fit sizes of pick-up beds. The cover 10 would be provided with a main body portion 12, having a heavy duty elastic band 13 all around the outside of the cover 10.

With particular reference to FIG. 2, there is shown how the band 13 is stretched (as indicated by the double-headed arrow) before it is placed on the vehicle 11 in order to place it on the vehicle 11.

FIG. 3 shows a portion of the band 13 after the stretching force has been released for retaining it on the vehicle 11.

The present invention provides a cover 10 for sanders and pick-up beds of all sizes, and for other equipment to keep the vehicle 11 and the equipment free from snow, ice, rain, etc.

The present invention provides a cover 10 with a heavy duty elastic band 13 all around the outside of the cover 10. This permits easy on and off of the cover 10 and access to the equipment and vehicle 11 being covered. It eliminates the need for tying or strapping the cover down.

The cover 10 can be made of canvas material, polyplastic, nylon, or any other suitable material as long as the material is waterproof to keep tie vehicle 11 and other objects being covered in a dry condition.

Preferably, but not necessarily, an optional feature of the present invention involves placing a magnet 14 (as best illustrated in FIG. 4) at the four corners of the novel cover 10.

It is to be understood that the present invention has been described hereinabove in exemplary fashion, and is not to be limited to the specifics described above. Indeed, the present invention includes all variations, modifications, and changes which embody the inventive concept.

1. A covering device for vehicles, equipment, and other external items, comprising:
a main body portion fabricated from canvas material, polyplastic, nylon, or any other suitable material which is waterproof; and
said main body portion is provided with a heavy duty elastic band disposed around an outer perimeter of said covering device to eliminate the need for tying or strapping down said covering device.

2. A covering device according to claim 1, including:
at least one magnet provided at said outer perimeter of said covering device.

3. A covering device, according to claim 1, including:
a magnet placed at four corners of said covering device.

4. A covering device, according to claim 2, including:
a magnet placed at four corners of said covering device.

5. A covering device according to claim 1, wherein:
said main body portion is provided with predetermined dimensions to fit sizes of pick-up truck beds.

6. A covering device according to claim 2, wherein:
said main body portion is provided with predetermined dimensions to fit sizes of pick-up truck beds.

7. A covering device according to claim 3, wherein:
said main body portion is provided with predetermined dimensions to fit sizes of pick-up truck beds.

8. A covering device according to claim 4, wherein:
said main body portion is provided with predetermined dimensions to fit sizes of pick-up truck beds.

9. A covering device according to claim 1, wherein:
said heavy duty elastic band is capable of being stretched in order to place it on the vehicle or other piece of equipment to be covered, and then released to provide a stretching force for retaining said covering device on the vehicle or equipment to be covered.

10. A covering device according to claim 2, wherein:
said heavy duty elastic band is capable of being stretched in order to place it on the vehicle or other piece of equipment to be covered, and then released to provide a stretching force for retaining said covering device on the vehicle or equipment to be covered.

11. A covering device according to claim 3, wherein:
said heavy duty elastic band is capable of being stretched in order to place it on the vehicle or outer piece of equipment to be covered, and then released to provide a stretching force for retaining said covering device on the vehicle or equipment to be covered.

12. A covering device according to claim 4, wherein:
said heavy duty elastic band is capable of being stretched in order to place it on the vehicle or other piece of equipment to be covered, and then released to provide a stretching force for retaining said covering device on the vehicle or equipment to be covered.

13. A covering device according to claim 5, wherein:
said heavy duty elastic band is capable of being stretched in order to place it on the vehicle or other piece of equipment to be covered, and then released to provide a stretching force for retaining said covering device on the vehicle or equipment to be covered.

14. A covering device according to claim 6, wherein:
said heavy duty elastic band is capable of being stretched in order to place it on the vehicle or other piece of equipment to be covered, and then released to provide a stretching force for retaining said covering device on the vehicle or equipment to be covered.

15. A covering device according to claim 7, wherein:
said heavy duty elastic band is capable of being stretched in order to place it on the vehicle or other piece of equipment to be covered, and then released to provide a stretching force for retaining said covering device on the vehicle or equipment to be covered.

16. A covering device according to claim 8, wherein:
said heavy duty elastic band is capable of being stretched in order to place it on the vehicle or other piece of equipment to be covered, and then released to provide a stretching force for retaining said covering device on the vehicle or equipment to be covered.

17. A covering device according to claim 1, wherein:
said heavy duty elastic band is provided all around the outside of said covering device.

18. A covering device according to claim 14, wherein:
said heavy duty elastic band is provided all around the outside of said covering device.

19. A covering device according to claim 15, wherein:
said heavy duty elastic band is provided all around the outside of said covering device.

20. A covering device according to claim 16, wherein:
said heavy duty elastic band is provided all around the outside of said covering device.
